(19) United States
(12) Patent Application Publication
(10) Pub. No.: US 2018/0094774 A1
(43) Pub. Date: Apr. 5, 2018

(54) SYSTEMS AND METHODS UTILIZING GLYCOL FOR HYDRATE PREVENTION WITH GLYCOL REGENERATION BY VARIABLE CONCENTRATION CONTROL

(71) Applicant: Chevron U.S.A. Inc., San Ramon, CA (US)

(72) Inventor: Andrew Mark Titley, Perth WA (AU)

(21) Appl. No.: 15/284,610

(22) Filed: Oct. 4, 2016

(51) Int. Cl. F17D 1/04; C10L 3/10

(52) U.S. Cl. CPC F17D 1/04; C10L 3/107

(57) ABSTRACT

Systems and methods use a glycol solution for inhibiting formation of hydrates in a flowline. The solution forms a mixture with the produced water thereby inhibiting the formation of natural gas hydrates in the flowline. After a period of use, a rich glycol solution forms which is then regenerated by heat in a heating means such as a reboiler located at a receiving facility, resulting in a lean glycol solution suitable for use inhibiting the formation of natural gas hydrates. The concentration of the lean glycol solution is varied based on input parameters selected from operating conditions of the fluid handling system to ensure that a required concentration of the lean glycol solution is met, as determined by a processor. A control means controls the lean glycol concentration using lean glycol temperature, lean glycol concentration and/or a duty of the heating means as a control variable.

### FIELD

The present disclosure relates to methods and systems for inhibiting the formation of natural gas hydrates in fluid handling systems that convey natural gas.

### BACKGROUND

Glycol solutions are commonly used to inhibit the formation of natural gas clathrate hydrates in pipelines, also referred to herein as flowlines, and equipment in fluid handling systems which convey fluids containing natural gas from oil and gas production sites to oil and gas processing facilities. Hydrates are formed from hydrocarbon gases such as methane in the presence of free water at high pressures and low temperatures. Hydrates can accumulate in pipelines and equipment, thus impeding production. Glycols used to mitigate hydrates include monoethylene glycol (MEG), diethylene glycol (DEG) and tri-ethylene glycol (TEG). “Lean glycol” solutions having a relatively high glycol concentration, e.g., 70-90% by volume, can be injected into fluid handling systems at wellheads whereupon the glycol mixes with produced water in the production fluids. The concentration of the lean glycol solution is in part determined by overall system hydraulics taking into account pressure drops and pumping power requirements. Higher glycol concentrations have relatively higher viscosities, but require lower volumetric flow rates for an equivalent hydrate inhibition. After a period of use in the flowline system, a “rich glycol” solution having a relatively lower glycol concentration, e.g., 30-40% by volume can be recovered and regenerated in a glycol regeneration or reclamation unit in which a portion of the water is removed.

Such glycols can degrade to form organic acid which can result in corrosion of the pipelines and equipment. The degradation temperature in part depends on the type of glycol. For MEG, DEG and TEG, the degradation temperatures are approximately 163° C., 162° C. and 206° C., respectively. The glycol degradation temperature is also dependent on oxygen content, particulate content and hydrocarbon content of the particular glycol solution. In order to minimize glycol degradation in glycol regeneration and reclamation units, reboiler and glycol film (i.e., glycol layer that forms on tubes) temperatures and heat fluxes can be limited. This in turn limits the concentration of glycol in the lean glycol produced in the glycol regeneration and reclamation units at a given pressure or vacuum. Higher concentrations of glycol in the lean glycol can be produced by using dry, stripping gas to further reduce the water concentration thereby increasing the glycol concentration. The use of stripping gas is undesirable from a greenhouse gas emissions point of view.

There remains a need for methods and systems for regenerating glycol solutions that minimize thermal degradation of the glycol and provide other benefits.

### SUMMARY

In one aspect, a method is provided for inhibiting formation of natural gas hydrates in a fluid handling system that conveys fluid comprising oil and natural gas wherein lean glycol solution containing monoethylene glycol, diethylene glycol and/or triethylene glycol is injected into a flowline, through which production fluids including liquid hydrocarbons, natural gas and produced water are flowing. The solution forms a mixture with the produced water thereby inhibiting the formation of natural gas hydrates in the flowline. The mixture is passed through the flowline to a receiving facility during which the mixture becomes a rich glycol solution. The rich glycol solution is then regenerated by heat with the heating means selected from a reboiler, a heating coil, an electric heater or a direct fired heater located at the receiving facility resulting in a lean glycol solution suitable for injecting into a flowline for inhibiting the formation of natural gas hydrates. A lean glycol concentration of the lean glycol solution is varied based on input parameters selected from a plurality of operating conditions of the fluid handling system to ensure that a required concentration of the lean glycol solution is met and the formation of natural gas hydrates is inhibited.

In another aspect, a system is provided for carrying out the method described above. An injection means is provided for injecting the glycol solution into a flowline through which production fluids including liquid hydrocarbons, oil, natural gas, and produced water are flowing for inhibiting the formation of natural gas hydrates. A heating means selected from the group consisting of a reboiler, a heating coil, an electric heater and a direct fired heater located at a receiving facility is provided in which a rich glycol solution received from the flowline is regenerated, thereby resulting in a lean glycol solution suitable for injecting into a flowline. A means for determining an input parameter selected from water flowrate in the flowline, minimum operating temperature in the flowline, percent free water in the flowline, and/or salt content in the flowline is provided. A processor for determining an estimated minimum required concentration of the lean glycol solution for hydrate inhibition using input parameters selected from the group consisting of fluid composition, water flow rate, and/or operating conditions is provided. A control means for controlling lean glycol concentration by using a control variable selected from a lean glycol temperature, lean glycol concentration and/or a duty of the heating means is provided. Lastly, a means is provided for varying one or more controlled variables selected from the lean glycol concentration, and/or a lean glycol flow rate to ensure that the estimated minimum required concentration is met and the formation of natural gas hydrates is inhibited.

### DESCRIPTION OF THE DRAWINGS

These and other objects, features and advantages of the present invention will become better understood with reference to the following description, appended claims and accompanying drawings. The drawings are not considered limiting of the scope of the appended claims. The elements shown in the drawings are not necessarily to scale. Reference numerals designate like or corresponding, but not necessarily identical, elements.

FIG. 1 is a schematic diagram illustrating a system according to one exemplary embodiment.

FIG. 2 is a schematic diagram illustrating a system according to another exemplary embodiment.

FIG. 3 is an exemplary plot of reboiler temperature vs. glycol concentration.

### DETAILED DESCRIPTION

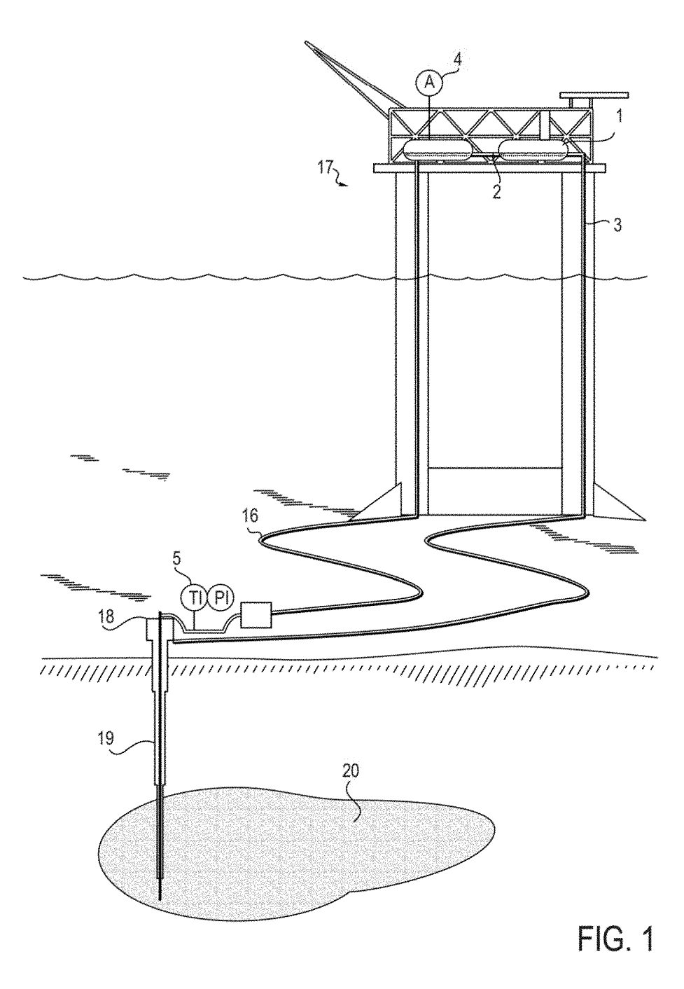

Referring to FIG. 1, systems and methods for inhibiting formation of natural gas hydrates in a fluid handling system will now be described. The fluid handling system includes a flowline 16 that conveys fluid, i.e., at least oil, natural gas and produced water.

A lean glycol solution containing monoethylene glycol, diethylene glycol and/or triethylene glycol is injected into the flowline 16. In one nonlimiting example, the injection can take place at a wellhead 18 where the flowline 16 meets a well 19 in a subterranean reservoir 20, using any suitable injection means, e.g. a pump, for injecting a glycol solution into a flowline. In the flowline 16, the solution forms a mixture with the produced water which inhibits the formation of natural gas hydrates in the flowline 16. The mixture is passed through the flowline to receiving facility 17 during which the mixture becomes a rich glycol solution. The receiving facility 17 can be an offshore platform or an onshore plant.

The rich glycol solution received from the flowline 16 is removed from the oil and gas into a separate stream, also referred to as the rich glycol stream, in a rich glycol line 2. The rich glycol stream is then regenerated in a heating means 1 located at the receiving facility 17. The heating means 1 can be any suitable heating means, such as a reboiler, a heating coil, an electric heater or a direct fired heater. As a result of regeneration, a lean glycol solution stream, in a lean glycol line 3, suitable for sending via flowline 16 for inhibiting the formation of natural gas hydrates is produced.

In one embodiment, a lean glycol concentration of the lean glycol solution can be varied based on certain input parameters which are selected from a number of operating conditions of the fluid handling system to ensure that a required concentration of the lean glycol solution is met and the formation of natural gas hydrates is inhibited. The required concentration of the lean glycol solution is determined as a minimum desired lean glycol concentration plus a margin of error to ensure that hydrates are inhibited. The operating conditions suitable for use as the input parameters can include, but are not limited to, the natural gas and liquid hydrocarbon fluid composition as determined by an appropriate analyzer 4 on the receiving facility 17, the flow rate of water in the flowline 16 as determined by an appropriate analyzer 4 on the receiving facility 17, a minimum operating temperature and/or pressure in the flowline 16 as determined by a sensor 5, percent free water flowing in the flowline 16 as detected by an appropriate analyzer 4 on the receiving facility 17, and salt content in fluids flowing the flowline 16 is detected by an appropriate analyzer 4 on the receiving facility 17.

The input parameters are used to estimate the minimum lean glycol concentration for hydrate inhibition using known equations or commercial software. Such known equations include, but are not limited to, the Hammerschmidt equation and the Nielsen-Bucklin equation, as described in Natural Gas Hydrates: A Guide for Engineers by John Carroll (Gulf Professional Publishing, Oct. 24, 2014). Commercial software includes, but is not limited to, Aspen HYSYS® (available from Aspen Technology, Inc., Bedford, Mass.) and PVTsim® (available from Calsep, Inc., Houston, Tex.).

The required concentration of the lean glycol solution can be varied over time as needed by continuous or periodic updating of the input parameters over time to ensure the concentration meets or exceeds the estimated minimum concentration when input parameters change during operation or over time. Input parameters that commonly vary include composition, water production and operating conditions. Composition varies as oil and gas reservoirs deplete with time or when new fields or wells start production. Water production is similar with water production often increasing over time with aquifer-driven reservoirs. Operating conditions also change, pressure may decline with time as reservoirs deplete and lower pressures are required to continue or maximize production. Operating temperature may also vary, for example higher water production can produce higher temperatures. As a result, the lean glycol concentration and volumetric flow can also be varied whilst still ensuring the inhibition of natural gas clathrate hydrates in pipelines. The current approach uses a lean glycol concentration and flow that cover the most onerous inhibition conditions. For less onerous conditions, the lean glycol flow is varied, rather than the concentration or a combination of concentration and flow. Reducing lean glycol concentration instead of or in addition to the lean glycol volumetric flowrate has a number of potential advantages. These include, but are not limited to: minimizing thermal degradation of the glycol; minimizing thermal degradation of other chemicals and contaminants; minimizing high temperature scaling and salt deposition; minimizing glycol losses in the regeneration or reclamation system; and minimizing glycol losses to the gas phase from the pipeline or flowline fluids. Note, the rich glycol flowrate and glycol concentration affect the equilibrium concentration of the glycol lost to the gas phase. Lower aqueous flowrates and higher glycol concentrations can increase glycol losses. This glycol can potentially accumulate in downstream systems, including acid gas removal units (AGRU), gas dehydration and other systems, where there is evidence that this can impact their performance. The impact on acid gas removal is addressed in Katz, Torsten, G. Sieder, and J. Hearn, “The effect of glycols on the performance of the acid gas removal process,” BASF SE, Ludwigshafen, Germany. LNG17, Houston (2013).

Higher water concentrations and lower glycol concentrations can improve the chemical kinetics of oxygen scavengers which are commonly used to reduce corrosivity in glycol systems. The operation of the glycol regeneration unit, reclamation unit or overall system can be simplified by reducing the volumetric turndown and maintaining flows (including column traffic) close to optimum conditions.

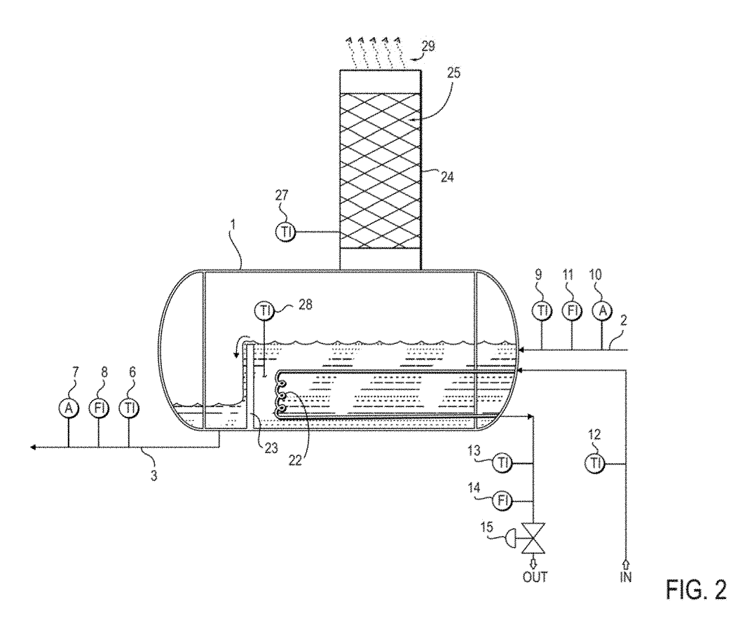

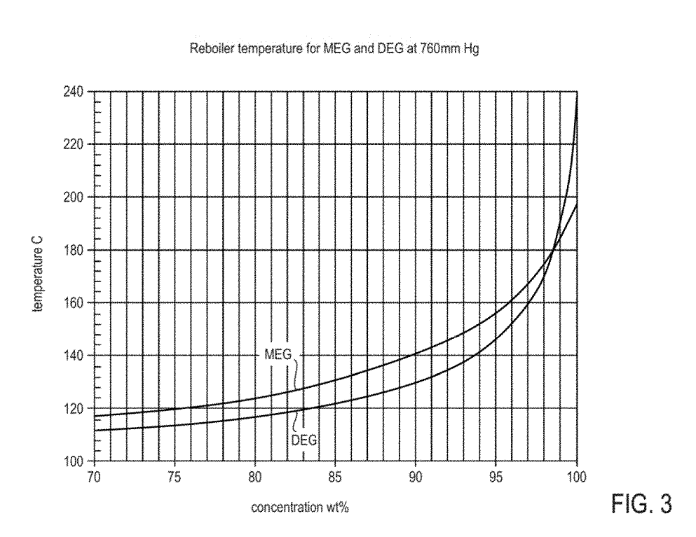

Referring to FIG. 2, the lean glycol concentration is controlled by controlling a variable selected from the lean glycol temperature, the lean glycol concentration and/or the reboiler duty. In one embodiment, since the lean glycol temperature correlates directly with lean glycol concentration (refer to FIG. 3), lean glycol temperature as measured by a temperature sensor 6 in a lean glycol outlet line from the heating means 1 located on receiving facility 17, rather than lean glycol concentration, can be used as the controlled variable for controlling lean glycol concentration. At some concentrations, such as below 75-80 wt %, accurate control of concentration using temperature becomes difficult as small changes in temperature can result in large changes in concentration. At such concentrations, direct measurement of the lean glycol concentration using an analyzer 7 in a lean glycol outlet line (or manual sampling and subsequent analysis) can be used and the lean glycol concentration is used as the controlled variable for controlling lean glycol concentration.

In embodiments in which lean glycol concentration is controlled by controlling the lean glycol temperature or the lean glycol concentration, the heating medium flow is controlled by adjusting a control valve 15 to control the flow of heating medium in the heating means 1. This is closed loop control with the controlled variable used to adjust the manipulated variable, in this case the control valve, which sets the heating medium flow. If the glycol temperature or lean glycol concentration is lower than required, the control valve 15 is opened more, the heating medium flow increases and more water, is vaporized. If the glycol temperature or lean glycol concentration is higher than required, the control valve 15 is closed more, the heating medium decreases and less water is vaporized.

In other embodiments, the heating means duty is used as the controlled variable for controlling the lean glycol concentration. This duty is the amount of energy that is transferred from the heating means 1 to the glycol concentration per unit time to heat it to the required regeneration temperature. In one embodiment, the heating means 1 is a reboiler. In such embodiment, the lean glycol concentration is controlled by estimating the reboiler duty required. Determination of reboiler duty requires a heat balance calculation around the reboiler. Reboiler duty required, as is known to one of ordinary skill in the art, is a combination of sensible heat and latent heat changes. The sensible heat change is calculated from the rich glycol flow rate as measured by a flow rate sensor 11 in a rich glycol inlet line 2 to the reboiler, the rich glycol solution inlet temperature as measured by a temperature sensor 9 in the rich glycol inlet line 2 and the lean glycol solution outlet temperature as measured by sensor 6 in the lean glycol outlet line 3. The lean glycol solution outlet temperature can be either a measured variable or a controlled variable based on the required lean glycol concentration using the direct correlation shown in FIG. 3. The latent heat change is calculated from the water vaporized, the difference between the water content needed in the lean glycol (the controlled variable), measured by analysis by analyzer 7 (or sampling), and the concentration of the rich glycol solution (a measured variable, as measured using an analyzer 10 in the rich glycol inlet line 2). An alternate method for calculating the water vaporized uses the difference in the rich glycol solution flowrate as measured by flow rate sensor 11 in the rich glycol inlet line 2 and the lean glycol solution flowrate as measured by a flow rate sensor 8 in the lean glycol outlet line 3. This converts the required lean glycol concentration to a reboiler duty (the manipulated variable).

Sensible heat change is calculated as follows:

$${Q}_{sensible} = rich glycol flowrate ( mass basis ) \times rich glycol specific heat capacity \times temperature change = FIRG \times Cp RG \times Δ T = FIRG \times Cp RG \times ( TLGout - TRGin )$$

### Where:

FIRG is the mass flowrate of rich glycol (measured at flow rate sensor 11): mass flow per unit of time;

Cp RG is the specific heat capacity of rich glycol: heat per mass per unit of temperature, typically a constant, known value or range of values depending on glycol concentration and/or operating conditions; and

TLGout and TRGin (measured at temperature sensors 6 and 9, respectively).

Latent heat change is calculated as follows:

$$\begin{matrix}{Q}_{latent} = water flowrate vaporized ( mass basis ) \times water latent heat \\ = FIW \times Δ HW\end{matrix}$$

### Where:

FIW is the mass flowrate of water vaporized and is calculated either by analysis of the change in water concentration of the rich glycol or by a change in mass flow between rich glycol and lean glycol or by an equivalent method, hence:

FIW=FIRG−FILG(measured at flow rate sensors 11 and 8 respectively) or =FIRG×(ALG−ARG)

(where A is the mass concentration of lean and rich glycol measured at analyzers 7 and 10 respectively); and

ΔHW is the latent heat of water: heat per mass, typically a constant, known value or range of values depending on operating conditions, for example operating pressure.

Total heat duty is therefore calculated as:

Q=FIRG×Cp RG×(TLGout−TRGin)+FIRG×(ALG−ARG).

Reboiler duty is the total heat duty Q for changing rich glycol to lean glycol. Reboiler duty is manipulated by altering the heating medium duty, typically by changing the flow of the heating medium by opening or closing a control valve 15 and calculating the duty from the heating medium flow rate as measured by a flow rate sensor 14, heating medium inlet temperature as measured by a temperature sensor 12 and heating medium outlet temperature as measured by a temperature sensor 13.

When the heating means uses a single component heat medium, such as hot oil or hot water, there is no phase change, and the reboiler duty is provided by sensible heat. For steam, which condenses to provide some or all of the heat, or other heating mediums with phase changes, then the reboiler duty is a combination of sensible heat and latent heat.

For simplicity, assuming no phase change:

$$\begin{matrix}Reboiler duty {Q}_{reboiler} = FIHM \times Cp HM \times Δ T \\ = FIHM \times Cp HM \times ( THMin - THMout )\end{matrix}$$

### Where:

FIHM is the mass flowrate of the heating medium (mass flow per unit of time, measured at flow sensor 14);

Cp HM is the specific heat capacity of heating medium (heat per mass per unit of temperature, typically a constant, known value or range of values depending on operating conditions); and THMin and THMout (measured at temperature sensors 12 and 13 respectively).

Combining equations for total heat duty Q and reboiler duty Q_{reboiler}:

FIHM×Cp HM×(THMin−THMout)=FIRG×Cp RG×(TLGout−TRGin)+FIRG×(ALG−ARG)

Re-arranging gives:

Heating medium flow FIHM=[FIRG×Cp RG×(TLGout−TRGin)+FIRG×(ALG−ARG)]/[Cp HM×(THMin−THMout)]

The reboiler duty is manipulated by altering the heating medium duty, typically by changing the flow of the heating medium by opening or closing heating medium control valve 15. Using heating means duty as the controlled variable can be a stable method for controlling glycol concentration.

A still column 24 is a typical arrangement; column 24 containing packing or trays 25 acts as a small distillation column which is more efficient than heating the rich glycol in a separator. Water vapor 29 is released from the column 24. The temperature sensor 28 in the reboiler 1 and the temperature sensor 27 on the column 24 are typical and can be used for control, performance monitoring or other diagnostics. The weir 23 in the reboiler 1 ensures that the heating coil 22 (or tubes, not shown) is always kept wet, otherwise it could operate dry.

In embodiments in which a heating coil 22 is used in the heating means 1, then heating medium flow rate as measured by a flow rate sensor 14, heating medium inlet temperature as measured by a temperature sensor 12, and heating medium outlet temperature as measured by a temperature sensor 13 are required to calculate the heating coil duty. In embodiments in which an alternate heating method is used, for example electric heater or direct fired heater (not shown), then different input parameters would be used to estimate duty, as would be understood to one of ordinary skill in the art. For example, electric power would be used to estimate duty for an electric heater.

In some embodiments, advantageously, only the lean glycol solution concentration is varied to control the amount of glycol in the fluid handling system to ensure that the required concentration is met and the formation of natural gas hydrates is inhibited. In such embodiments, the volumetric flow rate of the lean glycol solution is not varied to control the amount of glycol in the fluid handling system. In other embodiments, both the volumetric flow rate of the lean glycol solution and the concentration of the lean glycol solution are varied to control the amount of glycol in the fluid handling system. Varying lean glycol concentration according to methods described herein can advantageously reduce regeneration temperatures and in turn reduce thermal degradation of glycol and associated chemicals, and reduce scaling, salt deposition, equipment fouling, chemical losses, further improve chemical kinetics and equipment operation.

It should be noted that only the components relevant to the disclosure are shown in the figures, and that many other components normally part of a glycol regeneration and reclamation system are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. An improved method for inhibiting formation of natural gas hydrates in a fluid handling system that conveys fluid comprising oil and natural gas wherein lean glycol solution comprising monoethylene glycol, diethylene glycol and/or triethylene glycol is injected into a flowline, through which production fluids including liquid hydrocarbons, natural gas and produced water are flowing such that the monoethylene glycol, diethylene glycol and/or triethylene glycol forms a mixture with the produced water thereby inhibiting the formation of natural gas hydrates in the flowline; the mixture is passed through the flowline to a receiving facility during which passing the mixture becomes a rich glycol solution; and the rich glycol solution is regenerated in a heating means selected from the group consisting of a reboiler, a heating coil, an electric heater and a direct fired heater located at the receiving facility resulting in a lean glycol solution suitable for injecting into the flowline or other flowline for inhibiting the formation of natural gas hydrates, the improvement comprising:
varying a lean glycol concentration of the lean glycol solution based on input parameters selected from a plurality of operating conditions of the fluid handling system to ensure that a required concentration of the lean glycol solution is met and the formation of natural gas hydrates is inhibited.

2. The method of claim 1, further comprising varying a lean glycol flow rate of the lean glycol solution based on input parameters selected from a plurality of operating conditions during operation of the fluid handling system.

3. The method of claim 1, wherein the lean glycol solution is injected into the flowline at a wellhead.

4. The method of claim 1, wherein the receiving facility is located at an offshore platform or an onshore plant.

5. The method of claim 1, further comprising:
estimating a minimum required concentration of the lean glycol solution to inhibit the formation of natural gas hydrates using input parameters selected from the group consisting of a composition of the fluid, a water flowrate in the flowline, a minimum operating temperature in the flowline, a minimum operating pressure in the flowline, a percent free water in the flowline, a salt content in the flowline and combinations thereof;
continuous or periodic updating of the input parameters over time;
updating the estimated minimum required concentration of the lean glycol solution over time based on the updated input parameters; and
controlling the lean glycol concentration by controlling a variable selected from the group consisting of a temperature of the lean glycol concentration, a measured lean glycol concentration, a duty of the heating means and combinations thereof; such that the lean glycol concentration is at least the estimated minimum required concentration.

6. The method of claim 5, wherein lean glycol concentration is the controlled variable selected and lean glycol concentration is directly measured using an analyzer.

7. The method of claim 5, wherein the heating means is a reboiler; a reboiler duty is the controlled variable selected; and a required reboiler duty is determined using a heat balance calculation including sensible and latent heat changes using input parameters selected from the group consisting of a flow rate of rich glycol solution to the reboiler, a flow rate of lean glycol solution from the reboiler, an inlet temperature of rich glycol solution to the reboiler, an outlet temperature of lean glycol solution from the reboiler, a measured rich glycol solution concentration and combinations thereof.

8. The method of claim 5, wherein the outlet temperature of lean glycol solution from the reboiler is directly measured or is determined from a correlation of outlet temperature of lean glycol solution from the reboiler with the required concentration of the lean glycol solution.

9. The method of claim 7, wherein the reboiler duty is manipulated by opening or closing a control valve controlling flow of heating medium to or from the reboiler.

10. The method of claim 5, wherein the heating means is a heating coil using a heating medium; a heating coil duty is the controlled variable selected; and a required heating coil duty is determined using a heat balance calculation using input parameters selected from the group consisting of a flow rate of the heating medium in the heating coil, an inlet temperature of the heating medium to the heating coil, and an outlet temperature of the heating medium from the heating coil and combinations thereof.

11. The method of claim 5, wherein the alternate heating method is an electric heater or a direct fired heater, and input parameters are used to estimate and control an electric heater duty or a direct fired heater duty.

12. The method of claim 1, wherein a volumetric flow rate of the lean glycol solution is not varied.

13. The method of claim 1, further comprising varying a volumetric flow rate of the lean glycol solution.

14. A system for inhibiting the formation of natural gas hydrates in a fluid handling system that conveys natural gas, comprising:
a. an injection means for injecting a glycol solution into a flowline, through which production fluids including liquid hydrocarbons, oil, natural gas, and produced water are flowing for inhibiting the formation of natural gas hydrates;
b. a heating means selected from the group consisting of a reboiler, a heating coil, an electric heater and a direct fired heater located at a receiving facility in which a rich glycol solution received from the flowline is regenerated thereby resulting in a lean glycol solution suitable for injecting into the flowline or other flowline;
c. a means for determining an input parameter selected from the group consisting of water flowrate in the flowline, minimum operating temperature in the flowline, percent free water in the flowline, salt content in the flowline and combinations thereof;
d. a processor for determining an estimated minimum required concentration of the lean glycol solution for hydrate inhibition using input parameters selected from the group consisting of fluid composition, water flow rate, operating conditions and combinations thereof;
e. a control means for controlling lean glycol concentration using by using a control variable selected from the group consisting of a lean glycol temperature, lean glycol concentration and/or a duty of the heating means, and combinations thereof, and
f. a means for varying one or more controlled variables selected from the group consisting of the lean glycol concentration, a lean glycol flow rate and combinations thereof to ensure that the estimated minimum required concentration is met and the formation of natural gas hydrates is inhibited.

15. The system of claim 14, wherein the duty of the heating means is estimated or calculated using input parameters selected from the group consisting of a rich glycol flowrate, the lean glycol flowrate, the lean glycol concentration, a rich glycol concentration, the percent free water in the flowline, the lean glycol temperature, a rich glycol solution inlet temperature, and combinations thereof.

16. The system of claim 14, further comprising an injection means for injecting the glycol solution into the flowline at a wellhead.

17. The system of claim 14, wherein a volumetric flow rate of the lean glycol solution is not varied according to an amount of glycol needed in the fluid handling system.

18. The system of claim 14, wherein a volumetric flow rate of the lean glycol solution is varied according to an amount of glycol needed in the fluid handling system.

19. The system of claim 14, wherein the receiving facility is located at an offshore platform or an onshore plant.

20. The system of claim 14, further comprising an analyzer for directly measuring concentration of the lean glycol solution.

21. The system of claim 14, wherein the heating means is a reboiler and further comprising a control valve in a heating medium line from the reboiler for controlling flow of heating medium from the reboiler by opening or closing the control valve thereby manipulating duty of the reboiler.
